(19) United States
(12) Patent Application Publication
(10) Pub. No.: US 2024/0369514 A1
(43) Pub. Date: Nov. 7, 2024

(54) ACOUSTIC FLUID MONITORING SYSTEM

(71) Applicant: EXXONMOBIL TECHNOLOGY AND ENGINEERING COMPANY, Spring, TX (US)

(72) Inventors: Xinwei LAN, Breinigsville, PA (US); Katie M. WALKER, Spring, TX (US); Tao CHENG, Cypress, TX (US)

(73) Assignee: EXXONMOBIL TECHNOLOGY AND ENGINEERING COMPANY, Spring, TX (US)

(21) Appl. No.: 18/685,383

(22) PCT Filed: Jul. 12, 2022
(86) PCT No.: PCT/US2022/073618

§ 371 Date: Feb. 21, 2024

Related U.S. Application Data
(60) Provisional application No. 63/260,548, filed on Aug. 25, 2021.

(51) Int. Cl. G01N 29/02; G01F 1/66; G01F 1/74; G01N 15/00; G01N 15/02; G01N 29/22; G01N 29/42; G01N 29/44

(52) U.S. Cl. CPC G01N 29/02; G01F 1/666; G01F 1/74; G01N 15/02; G01N 29/222; G01N 29/42; G01N 29/4472; G01N 2015/0053; G01N 2291/02416

(57) ABSTRACT

An acoustic fluid monitoring system, as well as a method for monitoring fluid flow within a pipe using the acoustic fluid monitoring system, are provided herein. The system includes a first sensing probe and a second sensing probe that are acoustically coupled to the outer surface of a wall of a pipe through which a fluid is flowing. The first sensing probe operates at a first resonance frequency, and the second sensing probe operates at a second resonance frequency. The first sensing probe and the second sensing probe are configured to record a first acoustic signal and a second acoustic signal, respectively, corresponding to an acoustic wave propagating through the pipe wall. Characteristics of the first acoustic signal and the second acoustic signal, as well as the relationship between the first acoustic signal and the second acoustic signal, relate to one or more properties of the fluid flowing through the pipe.

### FIELD OF THE INVENTION

The techniques described herein relate to solid particle detection. More particularly, the techniques described herein relate to an acoustic fluid monitoring system that is attached to a pipe and is used to monitor properties of a fluid including solid particles that are flowing through the pipe.

### BACKGROUND OF THE INVENTION

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

During hydrocarbon production operations, wellbores are drilled to provide access to hydrocarbon fluids located within subterranean formations. Such hydrocarbon fluids are then produced from the corresponding subterranean formations. However, produced hydrocarbon fluids typically include some amount of sand and/or other solid particles. In general, this type of solids production is expected for new wells as a result of solids that accumulate within the wellbore during drilling and completion operations. Once the initial solids have been cleaned out of the wellbore, the flow of solids is typically stabilized as long as operating conditions are closely monitored and the formation itself remains stable. However, in many cases, the amount of solids production subsequently increases as a result of changing operating conditions and/or formation stability degradation, which may indicate that the formation is starting to break down as solids within the formation break loose and flow up the wellbore.

The production of sand and/or other sold particles may adversely impact hydrocarbon production operations in various ways. For example, such sand production may reduce well productivity (e.g., as a result of well sand-up), damage downhole equipment and/or surface facilities equipment (e.g., through erosion and/or equipment failure), hinder wellbore access, increase solids disposal requirements, contaminate the produced hydrocarbon fluids, and/or increase overall operating costs (e.g., such as costs associated with performing work-over operations). Over time, uncontrolled sand production can lead to extensive formation damage that leads to complete loss of production and abandonment of the well. Moreover, although there are multiple completion options for limiting sand production, such as, for example, gravel packing and screening, corrosion/scale control measures (e.g., chemical corrosion inhibitor injection), and cementing of the formation, such options do not obviate the need for reliable methods of monitoring fluctuations in sand production over time. Such monitoring is vital, not only for improving wellbore management procedures and streamlining clean-up scheduling, but also for rapidly addressing unplanned sand production events, which can be caused by the unexpected failure of downhole equipment, such as, for example, gravel packs and/or other sand management equipment. In general, such unplanned sand production events can cause extensive damage to both downhole and surface facilities equipment, such as, for example, chokes, packers, tubing, flowlines, pumps, separators, valves, and the like, if not immediately addressed. As a result, sand monitoring equipment is often used for prevention and/or early detection of such sand production events.

According to conventional sand monitoring techniques, passive acoustic sand detection devices are acoustically coupled to production pipes and then used to capture acoustic signals generated as a result of sand (and/or other solid particles) impinging on the inner walls of the corresponding pipes. This type of sand detection device is typically non-invasively mounted to the outer surface of the wall of the production pipe such that the device is positioned within around three diameters downstream of a bend/elbow or T-piece (where the term “diameter” refers to the diameter of the pipe) on the outside edge of the bend/elbow or T-piece. Mounting the device in this location ensures that the sand will impact the inner surface of the wall of the pipe with enough energy to enable the device's sensing probe to detect the traveling acoustic wave and then convert the acoustic wave into corresponding acoustic signals, where the characteristics of the acoustic signals are related to the sizes of the solid particles and/or the velocities with which the solid particles are traveling through the pipe (among other factors). The resulting acoustic signals, in combination with the aforementioned and other factors relating to the properties of the solid particles and the conditions within the pipe, arc used to provide qualitative (and sometimes quantitative) readings that indicate whether solids production is increasing, decreasing, or remaining relatively constant within the wellbore. In this manner, passive acoustic sand detection devices enable well operators to monitor the wellbore for sand conditions during hydrocarbon production operations.

However, although passive acoustic sand detection devices are widely used for sand monitoring, there are many issues that affect the operator's ability to effectively utilize and rely on the results obtained from such devices. One such issue is that conventional techniques for calculating the sand production rate and/or detecting unplanned sand production events tend to deliver inaccurate values, resulting in both false alarms and failure to provide appropriate alarms. This is due to the fact that the accuracy of a conventional passive acoustic sand detection device is largely dependent on the manner in which the device is calibrated. In particular, conventional passive acoustic sand detection devices require a complicated calibration process that involves determining correct zero and step value settings corresponding to the sensing probe, which are partly dependent on the conditions within the corresponding wellbore. Moreover, because this calibration process is tedious and costly (e.g., sometimes even requiring production to be temporarily halted), operators often do not re-calibrate such devices for each well in which they are implemented. Meanwhile, even properly-calibrated devices are only effective for a certain period of time (e.g., typically around six months) and are invalidated if production conditions change (e.g., based on flow regime changes over time and/or the application of gas lift technology within the well), resulting in the calibration values no longer holding true.

Furthermore, in addition to the calibration issue, several other common issues limit the effectiveness of conventional passive acoustic sand detection devices. A first common issue with conventional sand detection devices is that the acoustic signals recorded by the sensing probe include background noise in addition to the sound (and corresponding acoustic wave) generated by the sand and/or other solid particles impinging on the inner surface of the wall of the production pipe. Such background noise may include, for example, noise caused by slug flow and/or other flow regimes within the pipe. Moreover, in some cases, such background noise degrades the resulting acoustic signals to the point where the acoustic wave generated by the sand is fully covered by (and, thus, indistinguishable from) the background noise.

A second common issue with conventional sand detection devices is that such devices are often unable to capture the acoustic waves generated as a result of fine formation sand (e.g., sand particle sizes of less than around 40 to 50 microns (um)) impinging on the inner surface of the wall of the pipe under typical flow velocities. This inability is due to the fact that the sand particle size determines the center frequency that will be detected by the device's sensing probe when the particles impinge on the inner surface of the wall of the pipe (e.g., sand particle sizes of around 600 μm may correspond to a center frequency of around 200 kilohertz (kHz); sand particle sizes of around 300 μm may correspond to a center frequency of around 400 kHz; and sand particle sizes of around 50 μm may correspond to a center frequency of around 2500 kHz), with 2500 kHz being well above the frequency detection capabilities of many conventional sand detection devices.

A third common issue with conventional sand detection devices is that, for some wells with a high degree of gas flow, such sand detection devices continuously operate near the upper limit of their amplitude detection capabilities. As a result, the acoustic signals generated by the sand and other solid particles, in conjunction with the baseline acoustic signals (including any gas flow noise) recorded by the corresponding sensing probe, may overload the sensing probe's amplitude detection capabilities.

A fourth common issue with conventional sand detection devices is that sensor degradation may occur without the operator's knowledge. For example, a device may experience a loose connection that affects the acoustic coupling of the sensing probe with the outer surface of the wall of the pipe and, thus, negatively impacts the accuracy of the recorded acoustic signals. In this scenario, a catastrophic sand production event may occur before the operator even realizes that the device is not functioning properly.

In general, many of the aforementioned common issues with conventional sand detection devices are at least partially caused by (or exacerbated by) the fact that conventional passive acoustic sand detection devices are each designed to operate in a broad bandwidth with a nominally flat frequency response. As a result, conventional sand detection devices are limited in the sensitivity of the frequencies that they are capable of detecting, as mentioned above regarding the inability to detect acoustic signals corresponding to fine formation sand. In addition, because conventional sand detection devices are indiscriminate to a single resonance frequency, it can often be difficult to differentiate between acoustic signals corresponding to sand (and/or other solid particles) flowing within the pipe and acoustic signals corresponding to fluctuating background noise (e.g., noise generated by different flow regimes, such as, for example, slug flow).

The above described limitations of conventional sand detection devices have historically been difficult to overcome, at least in part because conventional signal processing methods for such devices are built upon the assumption that the devices are indiscriminate to a single resonance frequency. Accordingly, there is a long-felt but unsatisfied need for improved passive acoustic sand detection devices, as well as improved signal processing techniques that allow such devices to be easily and effectively utilized.

### SUMMARY OF THE INVENTION

An embodiment described herein provides an acoustic fluid monitoring system. The acoustic fluid monitoring system includes a first sensing probe and a second sensing probe that are acoustically coupled to the outer surface of a wall of a pipe through which a fluid is flowing. The first sensing probe operates at a first resonance frequency, and the second sensing probe operates at a second resonance frequency. The first sensing probe and the second sensing probe are configured to record a first acoustic signal and a second acoustic signal, respectively, corresponding to an acoustic wave propagating through the wall of the pipe. Characteristics of the first acoustic signal and the second acoustic signal, as well as the relationship between the first acoustic signal and the second acoustic signal, relate to one or more properties of the fluid flowing through the pipe.

Another embodiment described herein provides a computer-implemented method for monitoring fluid flow within a pipe using an acoustic fluid monitoring system. The method includes receiving, at a computing system, data corresponding to a first acoustic signal and a second acoustic signal, where the first acoustic signal and the second acoustic signal relate to an acoustic wave propagating through the wall of a pipe through which a fluid is flowing, and where the data corresponding to the first acoustic signal and the second acoustic signal are obtained using an acoustic fluid monitoring system including a first sensing probe and a second sensing probe, respectively, that are acoustically coupled to the outer surface of the wall of the pipe and are configured to operate at a first resonance frequency and a second resonance frequency, respectively. The method also includes processing, via the computing system, the data based on characteristics of the first acoustic signal and the second acoustic signal, as well as the relationship between the first acoustic signal and the second acoustic signal, to determine one or more properties of the fluid flowing through the pipe.

Another embodiment described herein provides an acoustic fluid monitoring system. The acoustic fluid monitoring system includes a first sensing probe and a second sensing probe acoustically coupled to the outer surface of a wall of a pipe through which a hydrocarbon fluid including solid particles is flowing and positioned within three times the diameter of the pipe from a point at which the direction of flow is altered within the pipe. The first sensing probe operates at a first resonance frequency, and the second sensing probe operates at a second resonance frequency. The first sensing probe and the second sensing probe are configured to record a first acoustic signal and a second acoustic signal, respectively, corresponding to an acoustic wave propagating through the wall of the pipe as a result, at least in part, of the impingement of at least a portion of the solid particles within the hydrocarbon fluid with the inner surface of the wall of the pipe at the point at which the direction of flow is altered within the pipe. Characteristics of the first acoustic signal and the second acoustic signal, as well as the relationship between the first acoustic signal and the second acoustic signal, relate to properties of the hydrocarbon fluid and the solid particles within the hydrocarbon fluid.

These and other features and attributes of the disclosed embodiments of the present disclosure and their advantageous applications and/or uses will be apparent from the detailed description which follows.

### BRIEF DESCRIPTION OF THE DRAWINGS

To assist those of ordinary skill in the relevant art in making and using the subject matter thereof, reference is made to the appended drawings, wherein:

FIG. 1 is a schematic view of an exemplary passive acoustic fluid monitoring system according to embodiments described herein;

FIG. 2 is a schematic view of another exemplary passive acoustic fluid monitoring system according to embodiments described herein;

FIG. 3 is a schematic view of another exemplary passive acoustic fluid monitoring system according to embodiments described herein;

FIG. 4 is a schematic view of another exemplary passive acoustic fluid monitoring system according to embodiments described herein;

FIG. 5 is a schematic view showing an exemplary positioning of an exemplary passive acoustic fluid monitoring system on the outer surface of a wall of a pipe;

FIG. 6 is a schematic view showing another exemplary positioning of another exemplary passive acoustic fluid monitoring system on the outer surface of a wall of the pipe;

FIG. 7 is a schematic view showing another exemplary positioning of another exemplary passive acoustic fluid monitoring system on the outer surface of a wall of the pipe;

FIG. 8 is a graph showing exemplary acoustic spectra that may be recorded and analyzed using a passive acoustic fluid monitoring system including two sensing probes according to embodiments described herein;

FIG. 9 is a process flow diagram of a method for monitoring fluid flow within a pipe using a passive acoustic fluid monitoring system; and

FIG. 10 is a block diagram of an exemplary cluster computing system that may be utilized to implement the sand monitoring techniques described herein.

It should be noted that the figures are merely examples of the present techniques and are

not intended to impose limitations on the scope of the present techniques. Further, the figures are generally not drawn to scale, but are drafted for purposes of convenience and clarity in illustrating various aspects of the techniques.

### DETAILED DESCRIPTION OF THE PREFERRED EMBODIMENTS

In the following detailed description section, the specific examples of the present techniques are described in connection with preferred embodiments. However, to the extent that the following description is specific to a particular embodiment or a particular use of the present techniques, this is intended to be for example purposes only and simply provides a description of the embodiments. Accordingly, the techniques are not limited to the specific embodiments described below, but rather, include all alternatives, modifications, and equivalents falling within the true spirit and scope of the appended claims.

### Definitions

At the outset, and for case of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the terms “a” and “an” mean one or more when applied to any embodiment described herein. The use of “a” and “an” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

As used herein, the term “acoustic wave” refers to a sound wave or mechanical vibration, which may be recorded as one or more corresponding acoustic signals, where the term “acoustic signal” refers to an analog or digital representation of an acoustic wave that is suitable for further analysis. Like other types of waves, acoustic waves can be differentiated by their frequency, amplitude, wavelength, phase velocity, and group velocity. The wavelength of a particular wave is defined as the wave's phase velocity divided by its frequency, where wavelength is measured in meters (m), phase velocity is measured in meters per second (m/s), and frequency is measured in Hertz (Hz). Moreover, the amplitude of a particular wave is the wave's maximum displacement from its rest position. When a wave is represented graphically, the wavelength may be identified by determining the distance between the successive peaks of the wave, and the amplitude may be identified by determining the distance between the wave's center line and its peak.

The term “acoustically coupled,” when used in reference to the relationship between two or more entities, means that the two or more entities are connected in a manner that facilities the transmission of acoustic waves between the two or more entities, or from at least one entity to at least one other entity.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities, should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the term “configured” means that a given clement, component, or other subject matter is designed and/or intended to perform a given function. Thus, the use of the term “configured” should not be construed to mean that the given clement, component, or other subject matter is simply “capable of” performing a given function, but that the element, component, or other subject matter is specifically selected, created, implemented, utilized, and/or designed for the purpose of performing the function.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

As used herein, the term “fluid” refers to combinations of gases, liquids, and solid particles, combinations of gases and solid particles, and/or combinations of liquids and solid particles. In other words, while the term “fluid” generally may also refer to individual gases, individual liquids, and combinations of gas and liquids (without the presence of solid particles), embodiments described herein assume that the fluid also includes at least some amount of solid particles, such as sand.

The term “non-invasive,” when used herein in reference to the passive acoustic fluid monitoring system described, means that the system is installed on an external surface (or external well) of a structure (e.g., a pipe) without necessitating the drilling of any holes/openings into the structure or accessing the internal region of the structure. However, the use of term “non-invasive” herein does not indicate that the external surface of the structure cannot be modified in any manner. For example, in some cases, one or more outer layers (such as one or more layers of paint and/or one or more layers of insulation material) may be removed from the external surface of the structure to allow metal-to-metal contact between the passive acoustic fluid monitoring system and the external surface of the structure, and the passive acoustic fluid monitoring system may still be referred to as being “non-invasive.”

The term “passive,” when used in reference to the passive acoustic fluid monitoring system described, means that the system does not send energy into its environment to perform the intended sensing function. In other words, while an active system might send an acoustic pulse into its environment and then listen for the reflection of the acoustic pulse, the passive system described herein listens without interacting with its environment.

As used herein, the term “pipe” refers to a fluid conduit having an axial bore. A pipe can have any cross-sectional shape, such as circular, square, rectangular, and the like. As an example, in the oil and gas industry, the term “pipe” includes flowlines and other tubular structures located within surface facilities associated with hydrocarbon wells, as well as underground pipelines for the transportation of hydrocarbon fluids. For the purposes of this disclosure, the term “pipe” may also include other tubular structures, which in the oil and gas industry include drill pipe, drill collars, tubing, casing, liners, risers, and the like. Other industries may employ various types of tubular structures, and these are also included within the definition of “pipe” herein.

The term “resonance frequency” (sometimes referred to as “resonant frequency”), when used herein in reference to a sensing probe, refers to the sensing probe's characteristic or natural frequency of vibration in response to excitation. The sensing probe will be most responsive to acoustic waves at this frequency and will most efficiently convert the acoustic waves at this frequency into an acoustic signal.

The term “sand” refers to sedimentary rock, sands, silicilytes, clays, carbonates, and other similar solid particles that may be co-produced with hydrocarbon fluids, such as heavy hydrocarbon fluids co-produced with sand as a slurry. Moreover, the term “sand” as used herein may also include solid particles that act as proppants within a fracturing fluid. Such solid particles may include, but are not limited to natural proppants, such as natural sands, resin-coated natural sands, shell fragments, and the like, and artificial proppants, such as sintered bauxite and ceramics, resin-coated ceramics, lightweight proppants, ultra-lightweight proppants, and the like.

As used herein, the term “sensing probe” refers to any suitable type of sensing element that is configured to detect and record acoustic waves propagating through a medium. Examples of sensing probes that may be used according to embodiments described herein include piezoelectric transducers, magnetostrictive transducers, electromagnetic acoustic transducers, and the like.

As used herein, the term “sensing unit” refers to one or more sensing probes in combination with the electronic circuit, memory, power component, data cable, and/or any other components that enable the sensing information recorded by the sensing probe(s) to be converted to a useable form and conveyed to a computing system.

Certain aspects and features are described herein using a set of numerical upper limits and a set of numerical lower limits. It should be appreciated that ranges from any lower limit to any upper limit are contemplated unless otherwise indicated. All numerical values are “about” or “approximately” the indicated value, and account for experimental errors and variations that would be expected by a person having ordinary skill in the art.

Furthermore, concentrations, dimensions, amounts, and/or other numerical data that are presented in a range format are to be interpreted flexibly to include not only the numerical values explicitly recited as the limits of the range, but also all individual numerical values or sub-ranges encompassed within that range, as if each numerical value and sub-range were explicitly recited. For example, a disclosed numerical range of 1 to 200 should be interpreted to include, not only the explicitly-recited limits of 1 and 200, but also individual values, such as 2, 3, 4, 197, 198, 199, etc., as well as sub-ranges, such as 10 to 50, 20 to 100, etc.

### Overview

Embodiments described herein provide improved passive acoustic fluid monitoring systems, as well as improved signal processing techniques corresponding to such improved fluid monitoring systems. Specifically, embodiments described herein provide passive acoustic fluid monitoring systems that are designed to operate in narrow bands centered around two or more resonance frequencies. In various embodiments, this capability is accomplished by including two or more sensing probes within each fluid monitoring system, with each probe centered around a different resonance frequency, although, in some cases, the same technical effect may be achieved by including only one sensing probe that is capable of operating across a broad band of frequencies. As described herein, utilizing such an improved fluid monitoring system enables the resulting acoustic signals, which include different bandwidths (or frequency responses) that are based on the resonance frequencies of the corresponding sensing probe(s), to be easily processed and analyzed using signal comparison techniques that account for the different bandwidths and response characteristics.

### Exemplary Configurations for Passive Acoustic Fluid Monitoring System Described Herein

According to embodiments described herein, a passive acoustic fluid monitoring system that is configured to operate at two more resonance frequencies is used to solve common issues that limit the effectiveness of conventional passive acoustic sand detection devices, as described above. In various embodiments, the passive acoustic fluid monitoring system includes a first sensing probe and a second sensing probe acoustically coupled to an outer surface of a wall of a pipe through which a fluid is flowing (e.g., within three times the diameter of the pipe downstream from a point at which the direction of flow is altered within the pipe), where the first sensing probe operates at a first resonance frequency and the second sensing probe operates at a second resonance frequency. In such embodiments, the first sensing probe and the second sensing probe are configured to record a first acoustic signal and a second acoustic signal, respectively, corresponding to an acoustic wave propagating through the wall of the pipe (e.g., as a result of solid particles impinging on the inner surface of the wall of the pipe at the point where the direction of flow within the pipe is altered), where characteristics of the first acoustic signal and the second acoustic signal, as well as the relationship between the first acoustic signal and the second acoustic signal (e.g., expressed as a ratio or other suitable mathematical function), relate to one or more properties of the fluid flowing through the pipe (such as, for example, properties relating to solid particles flowing through the pipe and/or a flow regime within the pipe). Moreover, in such embodiments, the first sensing probe and the second sensing probe may be configured as a single sensing unit or as separate sensing units. For embodiments in which the first sensing probe and the second sensing probe are configured as separate sensing units, the sensing units may be positioned at the same location along the length of the pipe and separated circumferentially by up to 180 degrees around the outer surface of the wall of the pipe, or the sensing units may be positioned at separate locations along the length of the pipe and separated along the length of the pipe by a distance of around one to two times the diameter of the pipe. Furthermore, in some embodiments, the passive acoustic fluid monitoring system may include any number of additional sensing probes, where each additional sensing probe operates at a different resonance frequency and is configured to record a corresponding acoustic signal, as described further herein.

The following is a discussion of several exemplary configurations for the passive acoustic fluid monitoring system described herein. However, this discussion is not intended to indicate that the passive acoustic fluid monitoring system described herein is limited to the configurations discussed below. Rather, those skilled in the art will appreciate that any number of different configurations are possible. Moreover, in practice, the specific configuration utilized may be determined based on the details of the specific implementation. For example, in some embodiments, the passive acoustic fluid monitoring system may only include a single sensing probe that is capable of operating at two or more resonance frequencies. In other embodiments, the passive acoustic fluid monitoring system may include two, three, four, five, or more sensing probes arranged in parallel and/or series in any suitable manner (where the terms “parallel” and “series” refer to the physical location of the probes with reference to each other and the pipe). Moreover, those skilled in the art will appreciate that the passive acoustic fluid monitoring system described herein is not limited to the components discussed below but, rather, may include fewer, additional, and/or alternative components, depending on the details of the particular implementation. Furthermore, it should be understood that the use of the term “passive acoustic fluid monitoring system” is not intended to indicate that the monitoring system described herein is limited to the detection of sand particles; rather, the monitoring system may be used to detect any suitable types of solid particles flowing within a pipe or tubular structure.

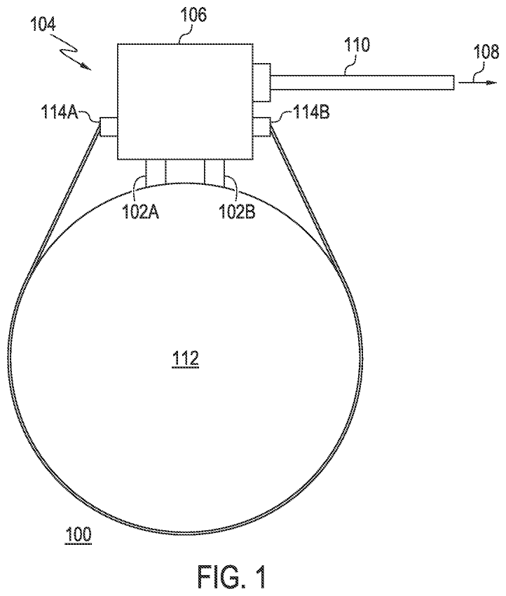

FIG. 1 is a schematic view of an exemplary passive acoustic fluid monitoring system 100 according to embodiments described herein. As shown in FIG. 1, the passive acoustic fluid monitoring system 100 includes two sensing probes 102A and 102B incorporated into a single sensing unit 104. In various embodiments, each sensing probe 102A and 102B includes a piezoelectric transducer or other suitable type of sensing element, optionally encased within an enclosure, such as a stainless-steel enclosure. Moreover, each sensing probe 102A and 102B is configured to operate at a different resonance frequency, as described further herein.

In addition, the passive acoustic fluid monitoring system 100 includes a number of additional components (not shown) that are encased within a housing 106 (such as, for example, a stainless-steel or aluminum housing), which serves as a safety barrier for the internal components. The internal components may include, but are not limited to, an electronic circuit, memory, and a power component. The electronic circuit may include, for example, a central processing unit (CPU), microprocessor, system on chip (SOC), digital signal processor (DSP), application specific integrated circuit (ASIC), and/or field programmable gate array (FPGA). The memory may include, for example, random access memory (RAM) (such as static RAM (SRAM), dynamic RAM (DRAM), synchronous DRAM (SDRAM), or the like) or read-only memory (ROM) (such as programmable ROM (PROM), erasable PROM (EPROM), electronically erasable PROM (EEPROM), or the like). In addition, the memory may include, for example, NAND flash and/or NOR flash. Moreover, the power component may be configured to provide power to the other components via one or more batteries and/or via connection to a power cable, for example.

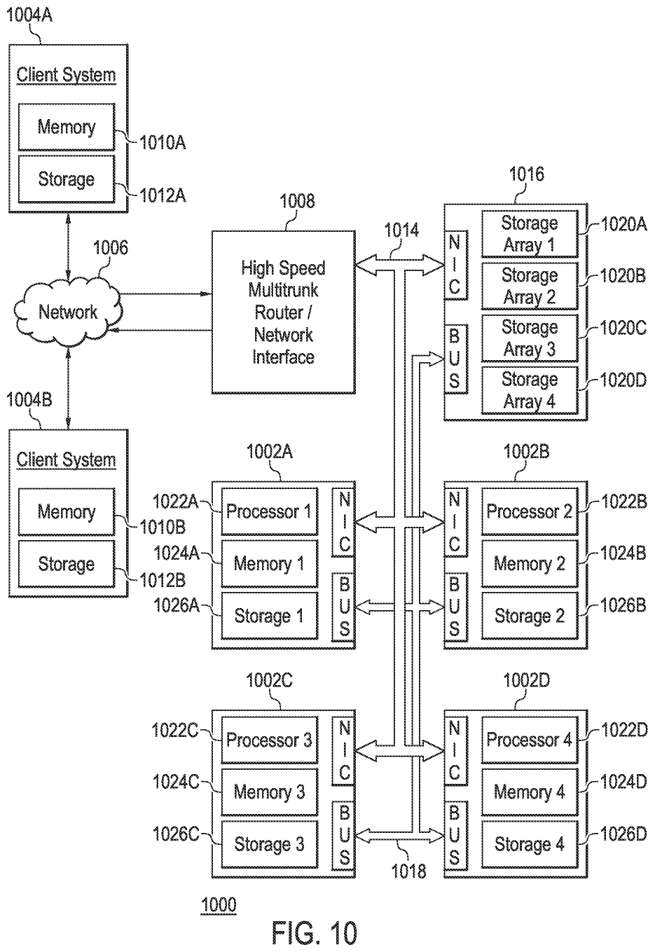

In various embodiments, the passive acoustic fluid monitoring system 100 is communicably coupled to a control unit (not shown), as indicated by arrow 108. In some embodiments, this is accomplished using a data cable 110, as shown in FIG. 1. In other embodiments, this is accomplished via wireless communication (e.g., Wi-Fi) using a wireless communication unit (not shown) of the passive acoustic fluid monitoring system 100, which may be included within the housing 106 along with the other internal components. Moreover, in various embodiments, the control unit is a remotely-located computing system (or cluster of computing systems) operated by one or more well operators. For example, in some embodiments, the control unit is the same as, or similar to, the exemplary cluster computing system described with respect to FIG. 10.

According to embodiments described herein, the passive acoustic fluid monitoring system 100 is non-invasively mounted to the outer surface of a wall of a pipe 112 in a manner that acoustically couples the sensing probes 102A and 102B with the pipe 112. In this manner, the sensing probes 102A and 102B are configured to detect (or sense) acoustic waves generated as a result of sand (and/or other solid particles) impinging on the inner surface of the wall of the pipe 112. The detected acoustic waves may then be converted into electronic data in the form of acoustic signals, which are transmitted to the control unit.

As shown in FIG. 1, the acoustic coupling of the sensing probes 102A and 102B to the outer surface of the wall of the pipe 112 is typically accomplished by fastening (e.g., clamping) the passive acoustic fluid monitoring system 100 to the pipe 112 using clamps 114A and 114B. However, those skilled in the art will appreciate that the acoustic coupling of the sensing probes 102A and 102B to the outer surface of the wall of the pipe 112 may also be accomplished in any other suitable manner. For example, the sensing probes 102A and 102B may be welded onto the pipe 112 or chemically bonded to the pipe 112 using epoxy. It should be noted, however, that the use of clamps or other types of fasteners is generally preferred, since their use allows the passive acoustic fluid monitoring system 100 to be selectively attached to, and detached from, the pipe 112.

According to embodiments described herein, because the sensing probes 102A and 102B operate at different resonance frequencies, the acoustic signals recorded by the sensing probes 102A and 102B, which correspond to the acoustic waves propagating through the pipe 112, include different bandwidths and different response characteristics. In various embodiments, such differences can be analyzed using the improved signal comparison techniques described herein, which are based on a comparison between two or more acoustic signals obtained with respect to two or more corresponding resonance frequencies. This analysis may be used to provide additional sensing information that is not provided by conventional acoustic sand detection devices, which operate indiscriminately to a single resonance frequency.

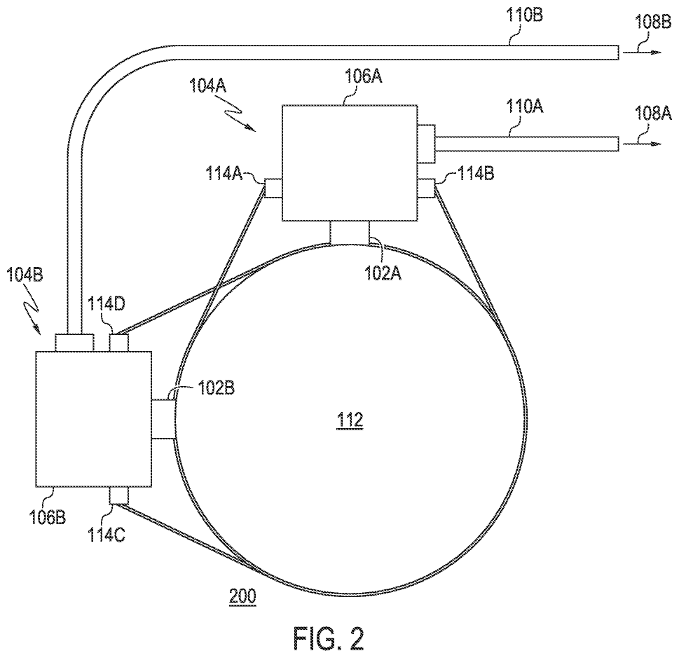

FIG. 2 is a schematic view of another exemplary passive acoustic fluid monitoring system 200 according to embodiments described herein. Like numbered items are as described with respect to FIG. 1. In various embodiments, the passive acoustic fluid monitoring system 200 of FIG. 2 is similar to the passive acoustic fluid monitoring system 100 of FIG. 1. However, within the passive acoustic fluid monitoring system 200 of FIG. 2, the two sensing probes 102A and 102B are incorporated into separate sensing units 104A and 104B around the outer surface of the wall of the pipe 112, where each sensing unit includes its own internal components (e.g., electronic circuit, memory, and power component) encased within its own housing 106A and 106B, respectively, as well as its own data cable 110A and 110B for communicating with the control unit, as indicated by arrows 108A and 108B. Moreover, each sensing unit may include its own clamps 114A and 114B, and 114C and 114D, respectively, for acoustically coupling the corresponding sensing probes 102A and 102B to the outer surface of the wall of the pipe 112.

Alternatively, in some embodiments, only one sensing unit (e.g., the first sensing unit 104A corresponding to the first sensing probe 102A) includes the internal components and the data cable 110A that is communicably coupled to the control unit. In such embodiments, the other sensing unit 104B may simply include the second sensing probe 102B, as well as a data cable that communicably couples the second sensing probe 102B to the internal components within the first sensing unit 104A.

In such embodiments, the passive acoustic fluid monitoring system 200 is configured to simultaneously transmit electronic data corresponding to both sensing probes 102A and 102B to the control unit, as described with respect to FIG. 1, rather than sending the data via separate data cables 110A and 110B.

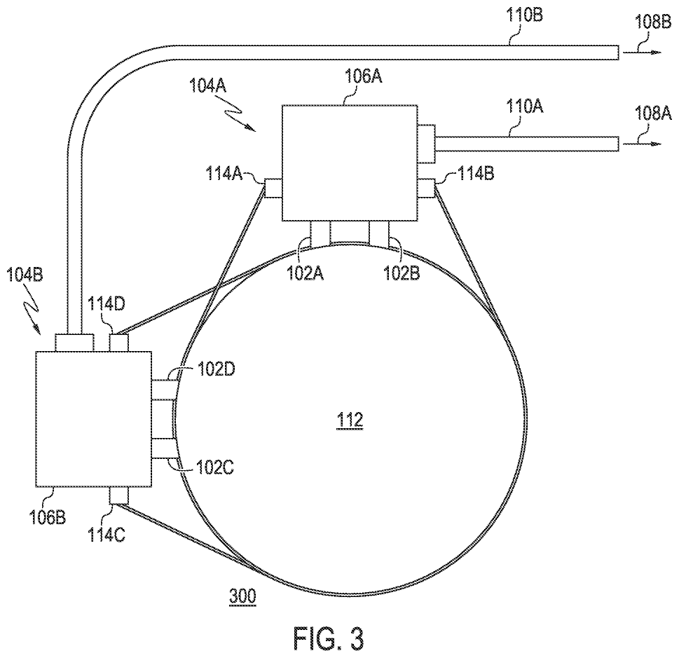

FIG. 3 is a schematic view of another exemplary passive acoustic fluid monitoring system 300 according to embodiments described herein. Like numbered items are as described with respect to FIGS. 1 and 2. In various embodiments, the passive acoustic fluid monitoring system 300 of FIG. 3 may be viewed as a combination of the passive acoustic fluid monitoring system 100 of FIG. 1 and the passive acoustic fluid monitoring system 200 of FIG. 2. In particular, the passive acoustic fluid monitoring system 300 of FIG. 3 includes two separate sensing units 104A and 104B, as described with respect to FIG. 2, where each sensing unit 104A and 104B includes two sensing probes 102A and 102B, and 102C and 102D, respectively, with each sensing probe 102A, 102B, 102C, and 102D operating at a different resonance frequency, as described with respect to FIG. 1. Accordingly, the passive acoustic fluid monitoring system 300 of FIG. 3 includes a total of four sensing probes 102A, 102B, 102C, and 102D. In various embodiments, including four sensing probes in this manner results in the collection of four separate acoustic signals corresponding to the acoustic waves propagating through the pipe, where each acoustic signal includes different bandwidths and different response characteristics that are based on the corresponding resonance frequencies. Moreover, the analysis of this larger number of acoustic signals may be used to provide additional sensing information as compared to the sensing information that is provided using two sensing probes.

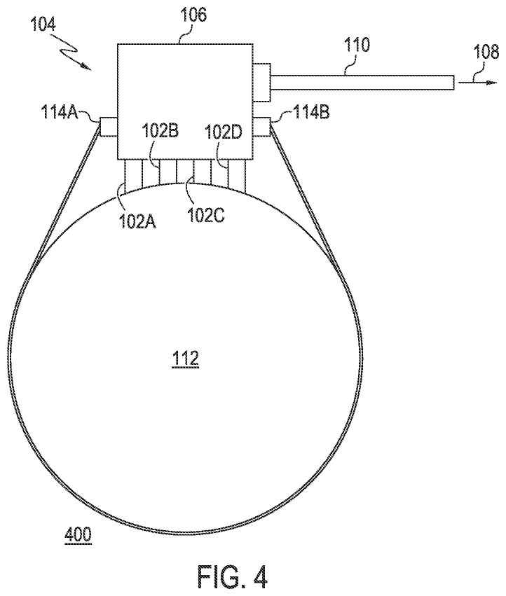

FIG. 4 is a schematic view of another exemplary passive acoustic fluid monitoring system 400 according to embodiments described herein. Like numbered items are as described with respect to FIG. 1. In various embodiments, the passive acoustic fluid monitoring system 400 of FIG. 4 is similar to the passive acoustic fluid monitoring system 100 of FIG. 1. However, two additional sensing probes 102C and 102D are included within the passive acoustic fluid monitoring system 400 of FIG. 4. In other words, the passive acoustic fluid monitoring system 400 of FIG. 4 include a single sensing unit with a total of four sensing probes 102A, 102B, 102C, and 102D, with each sensing probe including different bandwidths and different response characteristics that are based on the corresponding resonance frequencies. Therefore, as described with respect to FIG. 3, the passive acoustic fluid monitoring system 400 of FIG. 4 may provide additional sensing information as compared to the passive acoustic fluid monitoring system 100 of FIG. 1, which includes a total of two sensing probes 102A and 102B.

Those skilled in the art will appreciate that, although the sensing probes 102A, 102B, 102C, and 102D are depicted in FIG. 4 as being arranged entirely in series in terms of their physical location with reference to each other and the pipe 112, the sensing probes 102A, 102B, 102C, and 102D may also be arranged in any other suitable configuration. For example, in some embodiments the sensing probes 102A, 102B, 102C, and 102D may be arranged in series and in parallel, e.g., in a two-by-two arrangement.

Those skilled in the art will also appreciate that, while the acoustic fluid monitoring system is described herein as being non-intrusive, there are embodiments in which an intrusive acoustic fluid monitoring system could be used to achieve the same technical effect. In such embodiments, rather than non-intrusively mounting the sensing probes to the outer surface of the wall of the pipe, as described with respect to FIGS. 1-4, the sensing probes may be intrusively attached to the pipe in a manner that allows the sensing probes to directly contact the fluid flowing through the pipe. However, while such intrusively-mounted sensing probes may provide additional functionality as a result of the probes' direct contact with the flowing fluid, non-intrusively-mounted sensing probes are generally preferred since such probes are easier to install/uninstall and do not affect the structural integrity of the pipe.

Furthermore, those skilled in the art will appreciate that, while the acoustic fluid monitoring system is described herein as being passive, there are embodiments in which an active acoustic fluid monitoring system could be used to achieve the same technical effect. In such embodiments, the acoustic fluid monitoring system may operate by sending acoustic pulses into the pipe (or other structure) and then listening for the reflections of the acoustic pulses.

### Exemplary Positioning of Passive Acoustic Fluid Monitoring System

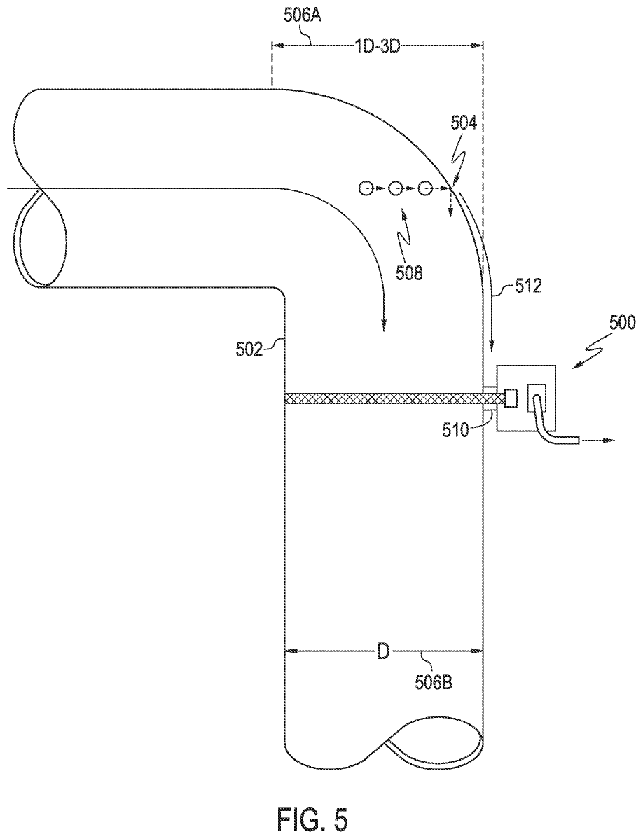

FIG. 5 is a schematic view showing an exemplary positioning of an exemplary passive acoustic fluid monitoring system 500 on the outer surface of a wall of a pipe 502. In some embodiments, the exemplary passive acoustic fluid monitoring system 500 shown in FIG. 5 corresponds to the exemplary passive acoustic fluid monitoring system 100 described with respect to FIG. 1. In other embodiments, the exemplary passive acoustic fluid monitoring system 500 shown in FIG. 5 corresponds to the exemplary passive acoustic fluid monitoring system 400 described with respect to FIG. 4. Moreover, in other embodiments, the exemplary passive acoustic fluid monitoring system 500 shown in FIG. 5 is configured in any other suitable manner including any suitable number of sensing probes arranged in parallel and/or series within a single sensing unit.

As shown in FIG. 5, the passive acoustic fluid monitoring system 500 is clamped (or otherwise fastened) to the outer surface of the wall of the pipe 502. Moreover, the passive acoustic fluid monitoring system 500 is positioned within around one to three diameters downstream of a bend/elbow 504 in the pipe 502 (or, in other embodiments, a T-piece or other suitable point where the direction of flow is altered within the pipe 502), as depicted schematically by arrow 506A, where the term “diameter” refers to the diameter of the pipe 502, as depicted schematically by arrow 506B. For example, in some embodiments, the passive acoustic fluid monitoring system 500 is positioned proximate to a bend/elbow or T-piece of a flowline upstream of a test separator and/or upstream of a first sand catcher, although the exact location is flexible. Mounting the passive acoustic fluid monitoring system 500 in this location ensures that, when sand and/or other solid particles flowing through the pipe 502 impact the inner surface of the wall of the pipe 502, as indicated by arrow 508, the system's sensing probe(s) 510 are able to detect the acoustic waves (which radiate outward including in the downstream direction) traveling through the wall of the pipe 502, as indicated by arrow 512, and then convert the detected acoustic waves into corresponding acoustic signals, where the characteristics of the acoustic signals are related to the sizes of the solid particles and/or the velocities with which the solid particles are traveling through the pipe 502 (among other factors). The resulting acoustic signals, in combination with the aforementioned and other factors relating to the properties of the solid particles and the conditions within the pipe 502, are then used as input for the signal comparison techniques described herein to provide qualitative and/or quantitative readings regarding the amount of solids productions and/or other flow characteristics within the pipe 502 (and the corresponding wellbore).

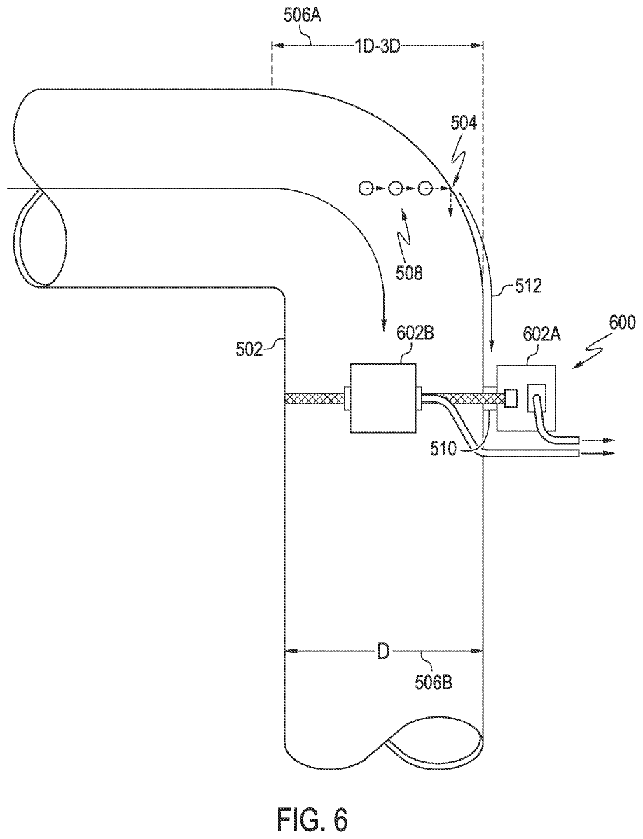

FIG. 6 is a schematic view showing another exemplary positioning of another exemplary passive acoustic fluid monitoring system 600 on the outer surface of the wall of the pipe 502. Like numbered items are as described with respect to FIG. 5. In some embodiments, the exemplary passive acoustic fluid monitoring system 600 shown in FIG. 6 corresponds to the exemplary passive acoustic fluid monitoring system 200 described with respect to FIG. 2. In other embodiments, the exemplary passive acoustic fluid monitoring system 600 shown in FIG. 6 corresponds to the exemplary passive acoustic fluid monitoring system 300 described with respect to FIG. 3. Moreover, in other embodiments, the exemplary passive acoustic fluid monitoring system 600 shown in FIG. 6 is configured in any other suitable manner including any suitable number of sensing probes arranged in parallel and/or series within two separate sensing units.

In various embodiments, the passive acoustic fluid monitoring system 600 is clamped (or otherwise fastened) to the outer surface of the wall of the pipe 502 in the same location as the passive acoustic fluid monitoring system 500 of FIG. 5. However, the passive acoustic fluid monitoring system 600 of FIG. 6 includes two separate sensing units 602A and 602B, rather than the single sensing unit shown in FIG. 5. Moreover, according to the embodiment shown in FIG. 5, the first sensing unit 602A is positioned at the 12 o'clock location on the outer surface of the wall of the pipe 502 (i.e., in the location where the sand and/or other solid particles are likely to impact the inner surface of the wall of the pipe 502 with the most force), while the second sensing unit 602B is positioned at the 3 o'clock location on the outer surface of the wall of the pipe 502. However, those skilled in the art will appreciate that the second sensing unit 602B may alternatively be positioned at the 6 o'clock location or the 9 o'clock location (or at any other suitable location around the outer surface of the wall of the pipe), depending on the details of the particular implementation. Stated another way, the sensing units 602A and 602B are positioned within the same plane and separated circumferentially by up to 180 degrees around the outer surface of the wall of the pipe 502. In this manner, the sensing units 602A and 602B are able to detect the acoustic waves radiating outward through the wall of the pipe 502 in the downstream direction in response to sand and/or other solid particles impacting the inner surface of the wall of the pipe 502.

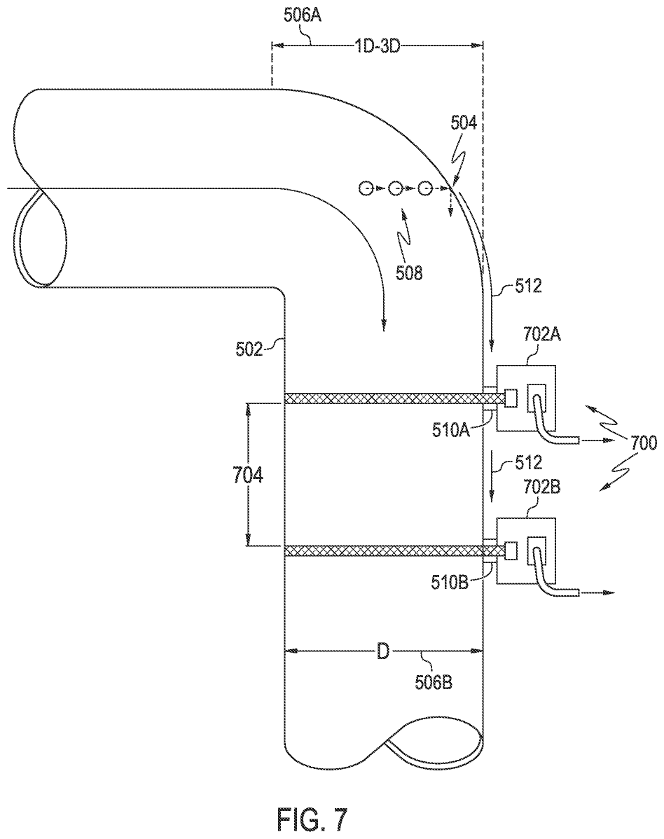

FIG. 7 is a schematic view showing another exemplary positioning of another exemplary passive acoustic fluid monitoring system 700 on the outer surface of the wall of a pipe 502. The exemplary passive acoustic fluid monitoring system 700 shown in FIG. 7 includes two sensing units 702A and 702B that are separated by a distance of around one to two diameters along the length of the pipe 502, as indicated by arrow 704, where the term “diameter” refers to the diameter of the pipe 502. Specifically, in the embodiment shown in FIG. 7, the first sensing unit 702A may be positioned at the 12 o'clock location on the outer surface of the wall of the pipe 502, and the second sensing unit 702B may be positioned at the 12 o'clock location on the outer surface of the wall of the pipe 502 within around one to two diameters downstream of the first sensing unit 702A. Accordingly, in such embodiments, the one or more sensing probes 510A and 510B corresponding to each sensing unit measure the acoustic waves caused the impingement of the sand and/other solid particles on the inner surface of the wall of the pipe 502 at different locations along the length of the pipe 502.

Those skilled in the art will appreciate that the positioning of the passive acoustic fluid monitoring systems 500, 600, and 700 described with respect to FIGS. 5, 6, and 7, respectively, are for illustrative purposes only. In practice, the passive acoustic fluid monitoring system described herein may be positioned in any suitable manner around the outer surface of the wall of a pipe, depending on the specific configuration of the passive acoustic fluid monitoring system as well as the details of the particular implementation.

### Exemplary Signal Comparison Techniques Described Herein

The signal comparison techniques described herein may be used, in conjunction with the acoustic signal data obtained via the passive acoustic fluid monitoring system described herein, to monitor the flow of sand and/or other solid particles within a corresponding pipe. Moreover, in some embodiments, the techniques described herein are additionally or alternatively used to measure other parameters relating to fluid flow within the pipe. As an example, such techniques may be used to identify and characterize different flow regimes within the pipe, including, for example, the approximate length and/or flow velocity of slug flow within the pipe and/or the volume or fraction of gas flow within the pipe.

It should be noted that, while the signal comparison techniques are primarily described with respect to the analysis of two acoustic signals obtained with respect to two corresponding resonance frequencies, this is for ease of discussion only. In practice, the signal comparison techniques may be used to analyze any number of acoustic signals obtained with respect to any number of additional corresponding resonance frequencies. Moreover, as described with respect to FIGS. 1-4, this may be accomplished using a passive acoustic fluid monitoring system including any suitable number of sensing probes.

As described herein, the passive acoustic fluid monitoring system includes one or more sensing probes operating at two or more resonance frequencies. For example, in various embodiments, the passive acoustic fluid monitoring system includes a first sensing probe that operates at a first resonance frequency and a second sensing probe that operates at a second resonance frequency. In various embodiments, the first resonance frequency may be relatively high, while the second resonance frequency may be relatively low. However, in practice, the resonance frequencies may be determined based on various factors, such as, for example, the expected range of sand particle sizes, expected flow rates, and expected flow regime conditions within the pipe. For example, in some embodiments, the resonance frequencies may be selected to provide relatively narrow bandwidths (or frequency responses) somewhere within the range of around 150 kHz to around 5,000 kHz, depending on the details of the particular implementation.

In various embodiments, because the sensing probes operate at different resonance frequencies, the data obtained from the sensing probes may be analyzed and compared according to the signal comparison techniques described herein to determine solids production and/or other flow characteristics within the corresponding pipe. In particular, analysis of the data according to the signal comparison techniques described herein may be used to solve (or alleviate) the four common issues that limit the effectiveness of conventional passive acoustic sand detection devices, as described above (and reiterated below).

With respect to the first common issue with conventional sand detection devices, the signal comparison techniques described herein may be used, in conjunction with the data obtained via the passive acoustic fluid monitoring system described herein, to avoid (or alleviate) the situation in which the background noise (e.g., including noise caused by slug flow and/or other flow regimes) within the pipe degrades the resulting acoustic signals to the point where the sound (i.e., the acoustic wave) generated by the sand is fully covered by (and, thus, indistinguishable from) the background noise. Specifically, continuing with the example described above (for ease of discussion), the two acoustic signals obtained using the two sensing probes may be processed together according to the signal comparison techniques described herein. Due to the different bandwidths and different response characteristics for the first sensing probe and the second sensing probe, each sensing probe would be expected to respond differently to the background noise (e.g., slug flow noise) in terms of the intensity of the resulting acoustic signals. However, the frequency spectrum for the noise would be expected to remain similar over time. Accordingly, the ratio (or another mathematical function) of the acoustic signals from the two sensing probes might not vary significantly or may vary in a trackable or predictable pattern. Furthermore, this concept also extends to the sound caused by sand (and/or other solid particles) flowing through the pipe. Specifically, each sensing probe would also be expected to respond differently to the sound caused by the sand (and/or other particles) in terms of the intensities of the resulting acoustic signals. As a result, the acoustic signals obtained from the two sensing probes can be processed and compared to determine whether the acoustic signal(s) obtained from either (or both) sensing probes indicate the presence of sand (and/or other solid particles). In various embodiments, this is accomplished by simply monitoring the ratio (or the other mathematical function) of one or more corresponding components of the acoustic signals, as recorded by the two sensing probes. However, those skilled in the art will appreciate that any other suitable method for comparing the data may alternatively be used. Moreover, as will be appreciated by those skilled in the art, the comparison of the data will account for the resonance frequency corresponding to each sensing probe, since the resonance frequency of a sensing probe has a direct impact on the sand particle sizes that can be effectively detected by the sensing probe.

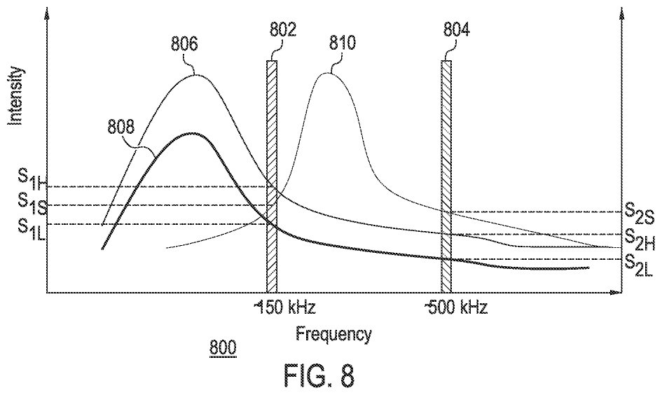

FIG. 8 is a graph 800 showing exemplary acoustic spectra that may be recorded and analyzed using a passive acoustic fluid monitoring system including two sensing probes according to embodiments described herein. Specifically, the passive acoustic fluid monitoring system includes a first sensing probe (represented graphically at 802) with a resonance frequency of around 150 kHz and a second sensing probe (represented graphically at 804) with a resonance frequency of around 500 kHz. Moreover, a first acoustic spectrum 806 (i.e., S_{H}) corresponds to a high slug flow condition; a second acoustic spectrum 808 (i.e., S_{L}) corresponds to a low slug flow condition; and a third acoustic spectrum 810 (i.e., S_{S}) corresponds to a sand flow condition including sand particle sizes of around 200-300 μm. As shown in FIG. 8, the signal intensities recorded by the first sensing probe for each flow condition (as shown by the dotted lines corresponding to S_{1H}, S_{1L}, and S_{1S}, respectively) varies in a predictable pattern as compared to the signal intensities recorded by the second sensing probe for each flow condition (as shown by the dotted lines corresponding to S_{2H}, S_{2L}, and S_{2S}, respectively). Accordingly, by using the first and second sensing probes as bandpass filters (and, optionally, applying additional hardware and/or software filters) and then comparing the fluctuations in the intensities recorded by the two sensing probes, it is possible to differentiate the background noise caused by the slug flow from the sound caused by sand impingement on the inner surface of the wall of the pipe. For example, in some embodiments, a simple ratio comparison method may be used. In such embodiments, it may be possible to detect an unplanned sand production event based on fluctuations in the signal intensity ratios. In particular, as shown in FIG. 8, the ratios S_{1H}/S_{2H} and S_{1L}/S_{2L} may remain relatively constant (or may vary according to easily-predictable or calibratable generic or specific flow conditions). However, the ratio (S_{1H}+S_{1S})/(S_{2H}+S_{2S}) may be significantly different (and/or may be less predictable/calibratable) from the ratios S_{1H}/S_{2H} and S_{1L}/S_{2L} when a sand production event occurs. Accordingly, using a passive acoustic fluid monitoring system that includes sensing probe(s) with two or more resonance frequencies, as described herein, increases the sensitivity of the sand signal in slug flow conditions (and/or other high background noise conditions), thus allowing for the detection of unplanned sand production events even when there is a high level of background noise.

Moreover, once the acoustic signal corresponding to the sand has been effectively distinguished from the background noise, it is possible to provide a qualitative assessment regarding the sand production conditions within the pipe, including whether sand production is increasing, decreasing, or remaining relatively constant. Furthermore, in addition to this qualitative assessment, it is possible to provide a quantitative assessment regarding the sand particle size ranges and/or specific slug flow characteristics (e.g., slug flow length and/or velocity) based on the different resonance frequencies of the sensing probes.

With respect to the second common issue with conventional sand detection devices, the signal comparison techniques described herein may be used, in conjunction with the data obtained via the passive acoustic fluid monitoring system described herein, to detect fine formation sand (e.g., sand particle sizes of less than around 40 to 50 μm). Specifically, when such fine formation sand collides with the inner surface of the wall of a corresponding pipe, the peak frequency from the induced acoustic spectrum is relatively high (e.g., in many cases, higher than the bandwidth that is covered by conventional sand detection devices). However, because the passive acoustic fluid monitoring system described herein operates at two or more resonance frequencies, with at least one resonance frequency selected to be higher than the expected resonance of the sand particles in terms of the corresponding bandwidth (or frequency response), it is possible to detect the collision of such fine formation sand with the inner surface of the wall of the pipe.

With respect to the third common issue with conventional sand detection devices, the signal comparison techniques described herein may be used, in conjunction with the data obtained via the passive acoustic fluid monitoring system described herein, to avoid (or alleviate) the situation in which a high degree of gas flow within the pipe causes the system to operate near the upper limit of its detection capabilities and, thus, be unable to detect the acoustic signals generated by the sand (and/or other solid particles). In particular, because the passive acoustic fluid monitoring system described herein includes at least one sensing probe that operates at a relatively high frequency, it may be in a better position to filter out the gas flow noise. In addition, in some embodiments, preamplifier settings and/or other scalable settings corresponding to the passive acoustic fluid monitoring system may be adjusted to further account for the high degree of gas flow.

With respect to the fourth common issue with conventional sand detection devices, the signal comparison techniques described herein may be used, in conjunction with the data obtained via the passive acoustic fluid monitoring system described herein, to avoid (or alleviate) the situation in which the sensor degrades without the operator's knowledge. Specifically, because the passive acoustic fluid monitoring system includes multiple sensing probes (or, in some cases, a single sensing probe operating at two different resonance frequencies), the resulting acoustic signals can serve as reference signals for each other to help identify any unknown factors that are affecting sensor performance. As an example, if the baseline signal for a first sensing probe suddenly decreases significantly, while the baseline signal for a second sensing probe remains unchanged, it is likely that the first sensing probe is not properly contacting the pipe wall and, thus, the acoustic coupling between the first sensing probe and the pipe has been compromised. In that case, it may be desirable to check the condition of the sensing probe. Furthermore, as another example, if the baseline signals for the first sensing probe and the second sensing probe both suddenly decrease significantly, it may be desirable to investigate whether the change is due to a flow regime change within the pipe or a sensing probe contact issue. At the same time, if the change is due to a flow regime change, the signal comparison techniques described herein may be utilized to ensure that an unplanned sand production event would still be properly detected using the passive acoustic fluid monitoring system.

### Exemplary Methods for Monitoring Solids Flow within Pipe Using Passive Acoustic Fluid Monitoring System Described Herein

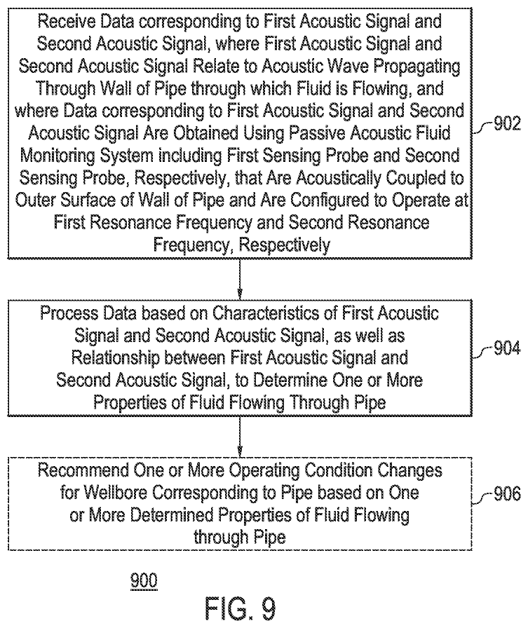

FIG. 9 is a process flow diagram of a method 900 for monitoring fluid flow within a pipe using a passive acoustic fluid monitoring system. The method 900 is implemented using the passive acoustic fluid monitoring system described herein, such as, for example, the passive acoustic fluid monitoring system, 100, 200, 300, or 400 described with respect to FIG. 1, 2, 3, or 4, respectively (or any suitable variations thereof). The passive acoustic fluid monitoring system may be positioned along a pipe in any suitable manner, such as, for example, as described with respect to FIG. 5, 6, or 7. Furthermore, the method 900 may be implemented using the signal comparison techniques described herein (or any suitable variation thereof), which are enabled by the use of the improved passive acoustic fluid monitoring system.

The method 900 begins at block 902, at which data corresponding to a first acoustic signal and a second acoustic signal are received at the computing system, where the first acoustic signal and the second acoustic signal relate to an acoustic wave propagating through the wall of a pipe through which a fluid is flowing, and where the data corresponding to the first acoustic signal and the second acoustic signal are obtained using a passive acoustic fluid monitoring system including a first sensing probe and a second sensing probe, respectively, that are acoustically coupled to the outer surface of the wall of the pipe and are configured to operate at a first resonance frequency and a second resonance frequency, respectively.

At block 904, the data are processed based on characteristics of the first acoustic signal and the second acoustic signal, as well as the relationship between the first acoustic signal and the second acoustic signal, to determine one or more properties of the fluid flowing through the pipe. In various embodiments, this may be accomplished using the signal comparison techniques described herein, which may include, for example, expressing the relationship between the two signals as ratios (and/or one or more other mathematical functions) between corresponding components of the acoustic signals. Moreover, in various embodiments, the one or more determined properties include properties relating to solid particles (e.g., sand) flowing through the pipe and/or properties relating to a flow regime within the pipe. In particular, in various embodiments, processing the data may allow sound caused by solid particles, such as sand, impinging on the inner surface of the wall of the pipe to be distinguished from background noise caused by the flow regime within the pipe. Furthermore, in various embodiments, because center frequencies for a first range of solid particles sizes are encompassed by a first bandwidth with the frequency closer to the first resonance frequency of the first sensing probe, and center frequencies for a second range of solid particle sizes are encompassed by a second bandwidth with the frequency closer to the second resonance frequency of the second sensing probe, processing the data at block 904 may include determining an approximate range of solid particles sizes present within the fluid based on characteristics of the first acoustic signal with respect to the first bandwidth and/or characteristics of the second acoustic signal with respect to the second bandwidth.

As a more specific example of fluid properties that may be determined at block 904, in some embodiments, processing the data may allow sound caused by solid particles, such as sand (and/or other proppant) within a fracturing fluid, to be monitored during a hydraulic fracturing operation. This sound may then be analyzed to determine changes in the amount of sand within the fluid. This, in turn, may be used to dynamically determine when the amount of sand within the fluid has declined to a sufficient level to successfully switch the well into normal production mode.

At optional block 906, one or more operating condition changes are recommended for a wellbore corresponding to the pipe based on the one or more determined properties of the fluid flowing through the pipe. For example, if an unplanned sand production event is detected at block 904 (e.g., based on changes in the ratios and/or other mathematical functions between the signal components), then the computing system may provide one or more sand management recommendations at block 906.

The process flow diagram of FIG. 9 is not intended to indicate that the steps of the method 900 are to be executed in any particular order, or that all of the steps of the method 900 are to be included in every case. Further, any number of additional steps not shown in FIG. 9 may be included within the method 900, depending on the details of the specific implementation.

It should be noted that, while embodiments are described herein with respect to the production of hydrocarbon fluids within the oil and gas field, this is for ease of discussion only. The present techniques are not limited to this particular application but, rather, may be used to detect and/or monitor any suitable type of solid particle flow within any suitable type of pipe, tubular, or similar structure, indiscriminately of the field and/or application for which it is applied.

### Exemplary Computing System for Implementing Signal Comparison Techniques Described Herein

FIG. 10 is a block diagram of an exemplary cluster computing system 1000 that may be utilized to implement the sand monitoring techniques described herein. The exemplary cluster computing system 1000 shown in FIG. 10 has four computing units 1002A, 1002B, 1002C, and 1002D, each of which may perform calculations for a portion of the sand monitoring techniques described herein. However, one of ordinary skill in the art will recognize that the cluster computing system 1000 is not limited to this configuration, as any number of computing configurations may be selected. For example, a smaller analysis may be run on a single computing unit, such as a workstation, while a large calculation may be run on a cluster computing system 1000 having tens, hundreds, thousands, or even more computing units.

The cluster computing system 1000 may be accessed from any number of client systems 1004A and 1004B over a network 1006, for example, through a high-speed network interface 1008. The computing units 1002A to 1002D may also function as client systems, providing both local computing support and access to the wider cluster computing system 1000.

The network 1006 may include a local area network (LAN), a wide area network (WAN), the Internet, or any combinations thereof. Each client system 1004A and 1004B may include one or more non-transitory, computer-readable storage media for storing the operating code and program instructions that are used to implement the sand monitoring techniques described herein. For example, each client system 1004A and 1004B may include a memory device 1010A and 1010B, which may include random access memory (RAM), read only memory (ROM), and the like. Each client system 1004A and 1004B may also include a storage device 1012A and 1012B, which may include any number of hard drives, optical drives, flash drives, or the like.

The high-speed network interface 1008 may be coupled to one or more buses in the cluster computing system 1000, such as a communications bus 1014. The communication bus 1014 may be used to communicate instructions and data from the high-speed network interface 1008 to a cluster storage system 1016 and to each of the computing units 1002A to 1002D in the cluster computing system 1000. The communications bus 1014 may also be used for communications among the computing units 1002A to 1002D and the cluster storage system 1016. In addition to the communications bus 1014, a high-speed bus 1018 can be present to increase the communications rate between the computing units 1002A to 1002D and/or the cluster storage system 1016.

The cluster storage system 1016 can have one or more non-transitory, computer-readable storage media, such as storage arrays 1020A, 1020B, 1020C and 1020D for the storage of data (such as data obtained from a passive acoustic fluid monitoring system), visual representations (such as visual representations of acoustic signals generated from the data), results (such as graphs, charts, and the like used to convey results obtained using the sand monitoring techniques described herein), program instructions (including program instructions for implementing the signal comparison techniques described herein), and other information concerning the implementation of the techniques described herein. The storage arrays 1020A to 1020D may include any combinations of hard drives, optical drives, flash drives, or the like.

Each computing unit 1002A to 1002D can have a processor 1022A, 1022B, 1022C and 1022D and associated local non-transitory, computer-readable storage media, such as a memory device 1024A, 1024B, 1024C and 1024D and a storage device 1026A, 1026B, 1026C and 1026D. Each processor 1022A to 1022D may be a multiple core unit, such as a multiple core central processing unit (CPU) or a graphics processing unit (GPU). Each memory device 1024A to 1024D may include ROM and/or RAM used to store program instructions for directing the corresponding processor 1022A to 1022D to implement the sand monitoring techniques described herein. Each storage device 1026A to 1026D may include one or more hard drives, optical drives, flash drives, or the like. In addition, each storage device 1026A to 1026D may be used to provide storage for models, intermediate results, data, images, or code associated with operations, including code used to implement the sand monitoring techniques described herein.

The present techniques are not limited to the architecture or unit configuration illustrated in FIG. 10. For example, any suitable processor-based device may be utilized for implementing all or a portion of embodiments of the sand monitoring techniques described herein, including without limitation personal computers, laptop computers, computer workstations, mobile devices, and multi-processor servers or workstations with (or without) shared memory. Moreover, embodiments may be implemented on application specific integrated circuits (ASICs) or very-large-scale integrated (VLSI) circuits. In fact, persons of ordinary skill in the art may utilize any number of suitable structures capable of executing logical operations according to embodiments described herein.

### Exemplary Embodiments of Present Techniques

In one or more embodiments, the present techniques may be susceptible to various modifications and alternative forms, such as the following embodiments as noted in paragraphs 1 to 20:
1. An acoustic fluid monitoring system, comprising: a first sensing probe and a second sensing probe acoustically coupled to an outer surface of a wall of a pipe through which a fluid is flowing; wherein the first sensing probe operates at a first resonance frequency and the second sensing probe operates at a second resonance frequency; wherein the first sensing probe and the second sensing probe are configured to record a first acoustic signal and a second acoustic signal, respectively, corresponding to an acoustic wave propagating through the wall of the pipe; and wherein characteristics of the first acoustic signal and the second acoustic signal, as well as a relationship between the first acoustic signal and the second acoustic signal, relate to one or more properties of the fluid flowing through the pipe.
2. The acoustic fluid monitoring system of paragraph 1, wherein the one or more properties of the fluid relate to at least one of solid particles flowing through the pipe or a flow regime within the pipe.
3. The acoustic fluid monitoring system of paragraph 2, wherein the one or more properties relating to the solid particles comprise solid particle sizes, and wherein center frequencies for a first range of solid particles sizes are encompassed by a first bandwidth with a corresponding frequency that is closer to the first resonance frequency and center frequencies for a second range of solid particle sizes are encompassed by a second bandwidth with a corresponding frequency that is closer to the second resonance frequency.
4. The acoustic fluid monitoring system of any of paragraphs 1 to 3, wherein the relationship between the first acoustic signal and the second acoustic signal is expressed as at least one of a ratio or another mathematical function between at least one component of the first acoustic signal and at least one corresponding component of the second acoustic signal.
5. The acoustic fluid monitoring system of any of paragraphs 1 to 4, wherein the first sensing probe and the second sensing probe are configured as a single sensing unit,
6. The acoustic fluid monitoring system of any of paragraphs 1 to 4, wherein the first sensing probe and the second sensing probe are configured as a first sensing unit and a second sensing unit, respectively.
7. The acoustic fluid monitoring system of paragraph 6, wherein the first sensing unit and the second sensing unit are positioned at a same location along a length of the pipe and are circumferentially separated by 45 degrees to 180 degrees around the outer surface of the wall of the pipe.
8. The acoustic fluid monitoring system of paragraph 6, wherein the first sensing unit and the second sensing unit are positioned at separate locations along a length of the pipe and are separated along the length of the pipe by a distance of less than one to two times a diameter of the pipe.
9. The acoustic fluid monitoring system of any of paragraphs 1 to 8, further comprising any number of additional sensing probes, wherein each additional sensing probe operates at a specific resonance frequency and is configured to record a corresponding acoustic signal.
10. A method for monitoring fluid flow within a pipe using an acoustic fluid monitoring system, comprising: receiving, at a computing system, data corresponding to a first acoustic signal and a second acoustic signal, wherein the first acoustic signal and the second acoustic signal relate to an acoustic wave propagating through a wall of a pipe through which a fluid is flowing, and wherein the data corresponding to the first acoustic signal and the second acoustic signal are obtained using an acoustic fluid monitoring system comprising a first sensing probe and a second sensing probe, respectively, that are acoustically coupled to an outer surface of the wall of the pipe and are configured to operate at a first resonance frequency and a second resonance frequency, respectively; and processing, via the computing system, the data based on characteristics of the first acoustic signal and the second acoustic signal, as well as a relationship between the first acoustic signal and the second acoustic signal, to determine one or more properties of the fluid flowing through the pipe.

11. The method of paragraph 10, wherein processing the data to determine the one or more properties of the fluid flowing through the pipe comprises processing the data to determine one or more properties relating to at least one of solid particles flowing through the pipe or a flow regime within the pipe.
12. The method of paragraph 11, comprising processing the data based on the characteristics of the first acoustic signal and the second acoustic signal, as well as the relationship between the first acoustic signal and the second acoustic signal, to distinguish sound caused by impingement of at least a portion of the solid particles with an inner surface of the wall of the pipe from background noise caused by the flow regime within the pipe.
13. The method of paragraph 11, wherein center frequencies for a first range of solid particles sizes are encompassed by a first bandwidth with a corresponding frequency that is closer to the first resonance frequency and center frequencies for a second range of solid particle sizes are encompassed by a second bandwidth with a corresponding frequency that is closer to the second resonance frequency, and wherein processing the data comprises determining an approximate range of solid particles sizes present within the fluid based on at least one of characteristics of the first acoustic signal with respect to the first bandwidth or characteristics of the second acoustic signal with respect to the second bandwidth.
14. The method of any of paragraphs 10 to 13, wherein processing the data based, at least in part, on the relationship between the first acoustic signal and the second acoustic signal comprises analyzing at least one of a ratio or another mathematical function between at least one component of the first acoustic signal and at least one corresponding component of the second acoustic signal.
15. The method of paragraph 14, comprising detecting an unplanned sand production event based on a change in the at least one of the ratio or the other mathematical function between the at least one component of the first acoustic signal and the at least one corresponding component of the second acoustic signal.
16. The method of any of paragraphs 10 to 15, comprising recommending, via the computing system, one or more operating condition changes for a wellbore corresponding to the pipe based on the one or more determined properties of the fluid flowing through the pipe.
17. An acoustic fluid monitoring system, comprising: a first sensing probe and a second sensing probe acoustically coupled to an outer surface of a wall of a pipe through which a hydrocarbon fluid comprising solid particles is flowing and positioned within three times a diameter of the pipe from a point at which a direction of flow is altered within the pipe; wherein the first sensing probe operates at a first resonance frequency and the second sensing probe operates at a second resonance frequency; wherein the first sensing probe and the second sensing probe are configured to record a first acoustic signal and a second acoustic signal, respectively, corresponding to an acoustic wave propagating through the wall of the pipe as a result, at least in part, of an impingement of at least a portion of the solid particles within the hydrocarbon fluid with an inner surface of the wall of the pipe at the point at which the direction of flow is altered within the pipe; and wherein characteristics of the first acoustic signal and the second acoustic signal, as well as a relationship between the first acoustic signal and the second acoustic signal, relate to properties of the hydrocarbon fluid and the solid particles within the hydrocarbon fluid.
18. The acoustic fluid monitoring system of paragraph 17, wherein the relationship between the first acoustic signal and the second acoustic signal is expressed as at least one of a ratio or another mathematical function between at least one component of the first acoustic signal and at least one corresponding component of the second acoustic signal.
19. The acoustic fluid monitoring system of paragraph 17 or 18, wherein the first sensing probe and the second sensing probe are configured as a first sensing unit and a second sensing unit, and wherein the first sensing unit and the second sensing unit are: positioned at a same location along a length of the pipe and circumferentially separated by 45 degrees to 180 degrees around the outer surface of the wall of the pipe; or positioned at separate locations along a length of the pipe and separated along the length of the pipe by a distance of less than one to two times a diameter of the pipe.
20. The acoustic fluid monitoring system of any of paragraphs 17 to 19, further comprising any number of additional sensing probes, wherein each additional sensing probe operates at a specific resonance frequency and is configured to record a corresponding acoustic signal.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present techniques may be modified and practiced in different but equivalent manners apparent to those skilled in the art having the benefit of the teachings herein. Furthermore, no limitations are intended on the details of formulation, construction, or design herein shown, other than as described in the claims below. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims.

What is claimed is:

1. An acoustic fluid monitoring system, comprising:
a first sensing probe and a second sensing probe acoustically coupled to an outer surface of a wall of a pipe through which a fluid is flowing;
wherein the first sensing probe operates at a first resonance frequency and the second sensing probe operates at a second resonance frequency;
wherein the first sensing probe and the second sensing probe are configured to record a first acoustic signal and a second acoustic signal, respectively, corresponding to an acoustic wave propagating through the wall of the pipe; and
wherein characteristics of the first acoustic signal and the second acoustic signal, as well as a relationship between the first acoustic signal and the second acoustic signal, relate to one or more properties of the fluid flowing through the pipe.

2. The acoustic fluid monitoring system of claim 1, wherein the one or more properties of the fluid relate to at least one of solid particles flowing through the pipe or a flow regime within the pipe.

3. The acoustic fluid monitoring system of claim 2, wherein the one or more properties relating to the solid particles comprise solid particle sizes, and wherein center frequencies for a first range of solid particles sizes are encompassed by a first bandwidth with a corresponding frequency that is closer to the first resonance frequency and center frequencies for a second range of solid particle sizes are encompassed by a second bandwidth with a corresponding frequency that is closer to the second resonance frequency.

4. The acoustic fluid monitoring system of claim 1, wherein the relationship between the first acoustic signal and the second acoustic signal is expressed as at least one of a ratio or another mathematical function between at least one component of the first acoustic signal and at least one corresponding component of the second acoustic signal.

5. The acoustic fluid monitoring system of claim 1, wherein the first sensing probe and the second sensing probe are configured as a single sensing unit.

6. The acoustic fluid monitoring system of claim 1, wherein the first sensing probe and the second sensing probe are configured as a first sensing unit and a second sensing unit, respectively.

7. The acoustic fluid monitoring system of claim 6, wherein the first sensing unit and the second sensing unit are positioned at a same location along a length of the pipe and are circumferentially separated by 45 degrees to 180 degrees around the outer surface of the wall of the pipe.

8. The acoustic fluid monitoring system of claim 6, wherein the first sensing unit and the second sensing unit are positioned at separate locations along a length of the pipe and are separated along the length of the pipe by a distance of less than one to two times a diameter of the pipe.

9. The acoustic fluid monitoring system of claim 1, further comprising any number of additional sensing probes, wherein each additional sensing probe operates at a specific resonance frequency and is configured to record a corresponding acoustic signal.

10. A method for monitoring fluid flow within a pipe using an acoustic fluid monitoring system, comprising:
receiving, at a computing system, data corresponding to a first acoustic signal and a second acoustic signal, wherein the first acoustic signal and the second acoustic signal relate to an acoustic wave propagating through a wall of a pipe through which a fluid is flowing, and wherein the data corresponding to the first acoustic signal and the second acoustic signal are obtained using a passive acoustic fluid monitoring system comprising a first sensing probe and a second sensing probe, respectively, that are acoustically coupled to an outer surface of the wall of the pipe and are configured to operate at a first resonance frequency and a second resonance frequency, respectively; and
processing, via the computing system, the data based on characteristics of the first acoustic signal and the second acoustic signal, as well as a relationship between the first acoustic signal and the second acoustic signal, to determine one or more properties of the fluid flowing through the pipe.

11. The method of claim 10, wherein processing the data to determine the one or more properties of the fluid flowing through the pipe comprises processing the data to determine one or more properties relating to at least one of solid particles flowing through the pipe or a flow regime within the pipe.

12. The method of claim 11, comprising processing the data based on the characteristics of the first acoustic signal and the second acoustic signal, as well as the relationship between the first acoustic signal and the second acoustic signal, to distinguish sound caused by impingement of at least a portion of the solid particles with an inner surface of the wall of the pipe from background noise caused by the flow regime within the pipe.

13. The method of claim 11, wherein center frequencies for a first range of solid particles sizes are encompassed by a first bandwidth with a corresponding frequency that is closer to the first resonance frequency and center frequencies for a second range of solid particle sizes are encompassed by a second bandwidth with a corresponding frequency that is closer to the second resonance frequency, and wherein processing the data comprises determining an approximate range of solid particles sizes present within the fluid based on at least one of characteristics of the first acoustic signal with respect to the first bandwidth or characteristics of the second acoustic signal with respect to the second bandwidth.

14. The method of claim 10, wherein processing the data based, at least in part, on the relationship between the first acoustic signal and the second acoustic signal comprises analyzing at least one of a ratio or another mathematical function between at least one component of the first acoustic signal and at least one corresponding component of the second acoustic signal.

15. The method of claim 14, comprising detecting an unplanned sand production event based on a change in the at least one of the ratio or the other mathematical function between the at least one component of the first acoustic signal and the at least one corresponding component of the second acoustic signal.

16. The method of claim 10, comprising recommending, via the computing system, one or more operating condition changes for a wellbore corresponding to the pipe based on the one or more determined properties of the fluid flowing through the pipe.

17. An acoustic fluid monitoring system, comprising:
a first sensing probe and a second sensing probe acoustically coupled to an outer surface of a wall of a pipe through which a hydrocarbon fluid comprising solid particles is flowing and positioned within three times a diameter of the pipe from a point at which a direction of flow is altered within the pipe;
wherein the first sensing probe operates at a first resonance frequency and the second sensing probe operates at a second resonance frequency;
wherein the first sensing probe and the second sensing probe are configured to record a first acoustic signal and a second acoustic signal, respectively, corresponding to an acoustic wave propagating through the wall of the pipe as a result, at least in part, of an impingement of at least a portion of the solid particles within the hydrocarbon fluid with an inner surface of the wall of the pipe at the point at which the direction of flow is altered within the pipe; and
wherein characteristics of the first acoustic signal and the second acoustic signal, as well as a relationship between the first acoustic signal and the second acoustic signal, relate to properties of the hydrocarbon fluid and the solid particles within the hydrocarbon fluid.

18. The acoustic fluid monitoring system of claim 17, wherein the relationship between the first acoustic signal and the second acoustic signal is expressed as at least one of a ratio or another mathematical function between at least one component of the first acoustic signal and at least one corresponding component of the second acoustic signal.

19. The acoustic fluid monitoring system of claim 17, wherein the first sensing probe and the second sensing probe are configured as a first sensing unit and a second sensing unit, and wherein the first sensing unit and the second sensing unit are:
positioned at a same location along a length of the pipe and circumferentially separated by 45 degrees to 180 degrees around the outer surface of the wall of the pipe; or
positioned at separate locations along a length of the pipe and separated along the length of the pipe by a distance of less than one to two times a diameter of the pipe.

20. The acoustic fluid monitoring system of claim 17, further comprising any number of additional sensing probes, wherein each additional sensing probe operates at a specific resonance frequency and is configured to record a corresponding acoustic signal.
